(19) United States
(12) Patent Application Publication
(10) Pub. No.: US 2010/0318656 A1
(43) Pub. Date: Dec. 16, 2010

(54) MULTIPLE-CHANNEL, SHORT-RANGE NETWORKING BETWEEN WIRELESS DEVICES

(75) Inventor: Bran Ferren, Beverly Hills, CA (US)

Correspondence Address: INTEL/BSTZ;BLAKELY SOKOLOFF TAYLOR & ZAFMAN LLP, 1279 OAKMEAD PARKWAY, SUNNYVALE, CA, 94085-4040, US

(73) Assignee: INTEL CORPORATION, Santa Clara, CA (US)

(21) Appl. No.: 12/817,106

(22) Filed: Jun. 16, 2010

Related U.S. Application Data
(60) Provisional application No. 61/187,520, filed on Jun. 16, 2009.

(51) Int. Cl. G06F 21/20; G06F 15/173

(52) U.S. Cl. 709/225

(57) ABSTRACT

Multiple-channel, short-range networking between wireless devices. An embodiment of a method includes sending a request from a mobile device, the request asking external devices to provide an announcement, the request being sent via a first wireless channel, and receiving announcements from one or more external devices including a first device. The method further includes transmitting data from the mobile device to the first device via the first wireless channel to negotiate a secure network, establishing the secure network connection on a second wireless channel, and transferring data securely from the mobile device to the first device via the second wireless channel using the secure network connection.

### RELATED APPLICATION

This application is related to and claims priority to U.S. Provisional Patent Application Ser. No. 61/187,520, filed Jun. 16, 2009 and entitled “Multi-Mode Handheld Electronic Device”, which is incorporated herein by reference.

### TECHNICAL FIELD

Embodiments of the invention generally relate to the field of electronic devices and, more particularly, to a method and apparatus for multiple-channel, short-range networking between wireless devices.

### BACKGROUND

Mobile devices, including cellular phones, smart phones, personal digital computers, and other similar devices, provide a wide variety of functions for various purposes, including business and personal use. Such devices may carry many different kinds of data, such as various forms of business data, family data, and personal data.

With the varied functionality and ease of transport of such mobile devices, there are opportunities for interconnection of such devices with other devices to take advantage of the functionality of the other devices. Such other devices may be located in many different physical environments as the mobile device is carried to different locations. In many cases a mobile device may be linked wirelessly with other devices, depending on the functionality of each device.

However, the data contained on a mobile device may be confidential. For this reason, the security of data transfers to other devices is of concern. In conventional operations, the establishment of a secure wireless link requires information regarding any intended network partners, thereby requiring certain knowledge of a user in establishing connections with new devices. There may be risk of eavesdropping by others over a wireless channel if security is not established, or if the wireless channel is used in the establishment of security for the wireless link.

### BRIEF DESCRIPTION OF THE DRAWINGS

Embodiments of the invention are illustrated by way of example, and not by way of limitation, in the figures of the accompanying drawings in which like reference numerals refer to similar elements.

FIG. 1 is an illustration of an embodiment of an ad hoc secure network;

FIG. 2 is an illustration of channels utilized by an embodiment of a mobile device establishing an a secure network;

FIG. 3 illustrates an embodiment of a mobile device;

FIG. 4 illustrates an embodiment of an external device that may provide a function for a mobile device;

FIG. 5 is a flow chart to illustrate an embodiment of a process for set up of a secure network; and

FIG. 6 illustrates an embodiment of mobile device.

### DETAILED DESCRIPTION

Embodiments of the invention are generally directed to multiple-channel, short-range networking between wireless devices.

As used herein:

“Mobile device or system” means a mobile electronic device or system including a cellular telephone, smart phone, personal digital device, mobile internet device, or handheld computer.

In some embodiments, a mobile device or system provides for multiple-channel, short-range networking between wireless devices.

As wirelessly networked mobile devices continue to proliferate, it may be desirable for these devices to interact with other devices in a useful way. The interconnection of mobile devices with other devices may allow for expansion in the versatility and functionality of such mobile devices,

In an example, a user in a hotel room or similar venue may prefer that a mobile device, such as a PDA (Personal Digital Assistant) or laptop computer, display a document, such as a PowerPoint presentation, on a large television screen in the room (as opposed to the smaller display on the mobile device). Similarly, the user may want the mobile device to utilize a high-end audio system in the room for the purpose of playing music that is stored on the mobile device.

However, data transferred wirelessly between devices is often confidential or personal, and thus interception of the data by others is of concern. If connections between devices are to be trusted for the secure transfer of data, particularly for wireless data transfers, the devices are generally required to establish a data connection in a secure manner, for example by exchanging encryption keys.

In some embodiments, a mobile device or system provides a process for setting up an ad hoc secure network, the network being a secure wireless network. In some embodiments, a mobile device or system establishes and utilizes an ad hoc secure network with an external device using multiple wireless communication channels, a first wireless channel being used to establish a connection and a second wireless channel being used to transfer data between the devices. In some embodiments, the first wireless channel may be used to request the connection while a third wireless channel is used to provide an announcement in response to the request. In some embodiments, the first wireless channel is a short-range channel, which may be directional and have limited penetration of surroundings, while the second wireless channel is higher bandwidth channel capable of transferring greater amounts of data than the first wireless channel.

In an example, a device or system provides a simple procedure by which a user may establish a connection with a nearby external device, such as a target external device that is within visual or audible range (e.g., a television that is across a room from a mobile device). In some embodiments, a network is established in an ad hoc fashion without reference to network addresses, device IDs, WEP (Wired Equivalent Privacy) or WPA (WiFi Protected Access) passwords, or similar information that is commonly required for the establishment of secure communications.

In some embodiments, a process may commence with the user placing a mobile device or system in an “establish link” mode. In some embodiments, the process may also include placing a target external device for linking into an “establish link” mode, such as by pressing a button on the target device to provide a request, while in certain other embodiments an external device may normally be in a state for receiving network requests.

In some embodiments, a mobile device then transmits a request that all nearby external devices announce or show themselves. In some embodiments, a request from a mobile device indicates a type of functionality required. For example, if a user is attempting to provide a display on a television screen the functionality might include a “large display”. In another example, if a user is attempting to provide a music signal to an audio system the functionality might include “high quality audio” or “stereo sound”. In this manner, the process operates such that only capable external devices that can provide the requested function need respond to the request.

A mobile device may be located in a physical location in which there are numerous potential external devices with the correct functionality nearby (such as in the same building as the mobile device), but perhaps only a single target device that is being considered by a user. For example, a hotel or residential complex may contain many televisions sets, but perhaps only a single television within the same room as the mobile device. In some embodiments, in order to minimize the number of non-usable or inappropriate devices that respond to a request, the first wireless channel for transmission of the request may be a short-range channel. In some embodiments, the first wireless channel may be a substantially non-penetrating channel, such that, for example, the request generally is limited to the nearby physical surroundings of the mobile device. In some embodiments, the channel may be a substantially directional channel, such that a user can direct a request towards a target device. In some embodiments, the establishment of the network may assist a user in ensuring that the target device is chosen. In an example, the establishment of a secure wireless network in an embodiment may be utilized to ensure that a broadcast of confidential or sensitive data from a mobile device to a target device, such as a television in a hotel room, is limited to the target device and is not received by multiple other devices, such as televisions in adjoining hotel rooms.

In some embodiments, a potential linking device responds to a request by providing an announcement using the first wireless channel or using another short-range and/or directional channel, referred to here as a third wireless channel.

In some embodiments, a first wireless channel may be a short-range radio channel. In some embodiments, a first wireless channel may be an optical or audio channel that will generally be limited to visual or hearing range from the mobile device. In some embodiments, the first wireless channel may be a channel using a transmission that is related to the type of device required. Thus, if a display device is required, the request may be transmitted by infrared signal, a technology that is generally compatible with a remote control for a television or other display system.

In some embodiments, external devices may respond to a request by producing a patterned response that is discernable by the mobile device. For example, if the mobile device includes a camera and requests a large display, a nearby television may respond by flashing one or more LED's (Light-Emitting Diodes) around the perimeter of the display or producing a pattern on the display itself. In another example, the television may produce an animated barcode with varying pattern, color, and intensity. In some embodiments, if a mobile device includes a microphone and requests high quality audio, a nearby audio system may respond by emitting sound of characteristic frequency and amplitude (such as a tone sequence). In some embodiments, the patterned information contains an identifier, where the identifier may be unique to the responding device. In some embodiments, upon receipt of the identifier, the mobile device transmits the identifier over the first wireless channel to confirm the handshake process. In some embodiments, the mobile device presents the identifier that is received from an external device to the user, while the identifier for the target device may be obtained from the target device, such as an identifier presented on a display or on exterior of the target device (such as a model number or serial number), thus allowing the user to compare the identifiers and confirm that the target device has been correctly identified. In this manner, the handshake process requires physical proximity, with the mobile device being required to be in visual or audible range of the chosen target device. Further, in this manner the handshake may be limited to external devices that are useful to the user (because such devices are in visual or audible range of each other), while other devices are automatically excluded.

In some embodiments, a mobile device or external device may continually broadcast a request or an announcement, respectively. For example, a mobile device may broadcast a periodic beacon requesting announcements from external devices, or an external device may broadcast a periodic announcement advertising the external device's availability. In some embodiments, a mobile device or external device providing a continual broadcast of a request or announcement may use a very short-range signal such that only devices in close proximity will receive the broadcast. In some embodiments, the mobile device and external device may require physical contact, such as tapping the mobile devices together, before initiating a handshake process between the devices. In some embodiments, the continuous request or announcement may utilize a separate wireless channel for the periodic requests, announcements, or both, which may be referred to as a zero wireless channel (CH-0) in contrast to the first and second wireless channels. In some embodiments, upon receiving a request or announcement via the zero wireless channel, the mobile device may utilize the first wireless channel, or first and third wireless channels, to establish a secure wireless network for communication of data.

In some embodiments, signals provided by an external device may be formatted to be discreet, the signals being transmitted in a manner that may not be noticed by persons who are nearby. In some embodiments, an external device using an audio channel may embed the announcement in an audio signal such that the signal is not discernable from the other sound. In some embodiments, an external device using an optical channel may similarly embed the signal in an optical signal such that a person present would not see or notice the signal. In some embodiments, a signal from an external device may be formatted to be of short duration, such that the signal (including an optical or audio signal) would occur too quickly to be noticed by a person who is nearby. In some embodiments, a signal from an external device may be formatted to be low in intensity, such that a signal would not be noticed by a person who is present in the vicinity. For example, an audio signal may be a low volume signal that is difficult for a user to hear. In some embodiments, a signal may utilize a frequency that is not discernable by a human user, such as an audio signal using an ultrasonic frequency that is not audible to human hearing.

After the handshake between the mobile device and the responding target device is completed, the mobile device and the target device may exchange any additional information required to set up or negotiate the network connection, such as encryption keys, data rates, and compression standards. In some embodiments, the subsequent exchange of information may occur over the same channel or channels as the handshake. In some embodiments, using the short-range channel(s) makes it more difficult for an eavesdropper to intercept the information exchanged prior to the establishment of the secure network on the second channel. This provides a layer of security beyond that of the key exchange protocol itself and may mask even the presence of a secure network from eavesdroppers. In some embodiments, subsequent secure communications take place over the second wireless channel. In some embodiments, the mobile device may cache the parameters of the negotiated connection with an associated location stamp (such as GPS (Global Positioning System) data) determined by a GPS receiving element to ease the setup of future connections to the external device.

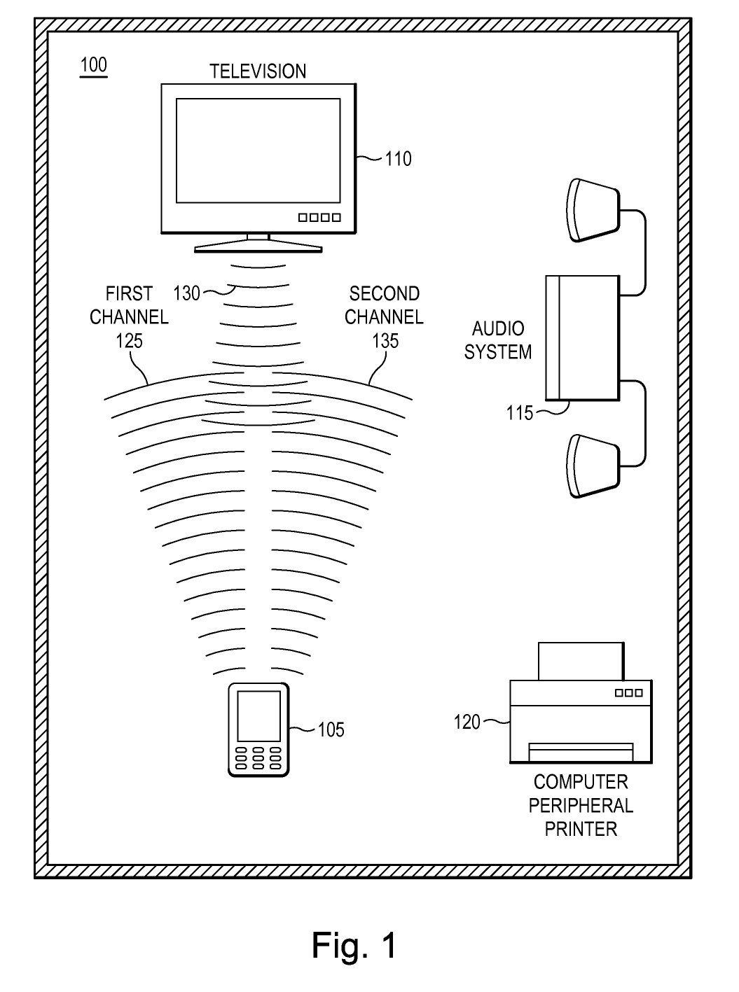

FIG. 1 is an illustration of an embodiment of an ad hoc secure network. In this illustration, a mobile device 105 is located within a certain environment 100. The environment 100 may be a room, a house, or other physical environment. In some embodiments, the environment 100 may include one or more external devices that may be linked with the mobile device 105 to establish an ad hoc secure network, the secure network being established using multi-channel communications. In the illustrated example, the environment 100 includes a television or other display system 110, an audio device or system such as audio system 115, and a computer peripheral such as a printer 120. The illustrated devices are simply examples, and the mobile device 105 may establish a network with other types of devices.

As provided in FIG. 1, the mobile device 105 provides a request function via a first wireless channel 125, where the request may be intended to locate an external device capable of performing an external function using a second wireless channel 135. In some embodiments, the request may include identification of the external function needed, and request that external devices that are capable of providing the desired function provide an announcement. In some embodiments, one or more external devices that are capable of providing the desired function and that receive the request over the first wireless channel provide an announcement over a wireless channel for announcements 130. In some embodiments, the wireless channel for announcements 130 is the first wireless channel, and in some embodiments, the wireless channel for announcements is a third wireless channel.

In some embodiments, the first wireless channel in comparison to the second wireless channel is a short-range channel such that only nearby devices will receive requests and other messages needed to establish a secure connection from the mobile device. In some embodiments, the first wireless channel has limited penetration through solid surfaces such that messages from the mobile device are limited to a small geographic space. In some embodiments, the third wireless channel (if used by a device to transmit to the mobile device) may have similar characteristics as the first wireless channel. In some embodiments, the second wireless channel may be a longer range channel than the first wireless channel, and may penetrate more readily through solid objects than the first wireless channel. In some embodiments, the first wireless channel may be a channel that is more directional than the second wireless channel, and thus a request made via the first wireless channel may be directed towards a target device.

In some embodiments, the first wireless channel is a low bandwidth channel in comparison with the second wireless channel, and may not be sufficient to carry the data required for performance of the desired function in cooperation with the target device.

In some embodiments, the wireless channels used for setup and operation of an ad hoc secure network may be related to the type of function that is requested and the intended type of device to provide the function. In an example, mobile device 105 may send a request via a first wireless channel 125 to request a display system for the display of data from the mobile device 105. In some embodiments, the first wireless channel may be an optical channel, such as a transmission via an infrared signal, and may be directed towards the television 110. In some embodiments, the announcement from the display system may also use the first wireless channel, or may use a third wireless channel, where the third wireless channel may have similar attributes to the first wireless channel. In the example, an announcement in response to the request may be sent via an infrared signal, or may be returned via another optical channel. In the example, the announcement may be returned by a visual display from the display screen, where the mobile device is able to detect the visual display using a camera function. In some embodiments, communications from the linked target device may use a combination of channels, such as providing an initial response via a display screen and additional security messages or responses via the first wireless channel.

While the figures and discussion herein generally describe a mobile device setting up a secure network with a single external device, embodiments of the invention are not limited to this outcome. In some embodiments, a mobile device may set up secure wireless networks with multiple devices. In some embodiments, a mobile device receiving announcements from multiple external devices may establish secure networks with two or more of the external devices. In some embodiments, a mobile device may establish secure networks with multiple external devices to perform a single function, for example multiple devices to perform display or audio functions, and in some embodiments a mobile device may establish secure networks with multiple external devices to perform multiple functions. In an example, mobile device 105 may receive announcements from television 110 to provide a display function and audio system 115 to provide an audio function. In this example, the mobile device 105 may establish a first secure network with the television 110 to provide the video portion of audio-video data contained on the mobile device 105 and establish a second secure network with the audio system 115 to provide the audio portion of the audio-video data. In some embodiments, multiple external devices may be grouped, in which one or more external devices are in a first group and one or more external devices are in a second group. For example, a first group may represent one or more external devices performing a first function and a second group may represent one or more external devices performing a second function. In this example, a first stream of data may be sent from a mobile device to the one or more external devices in the first group and a second stream of data may be sent to the one or more external devices in the second group.

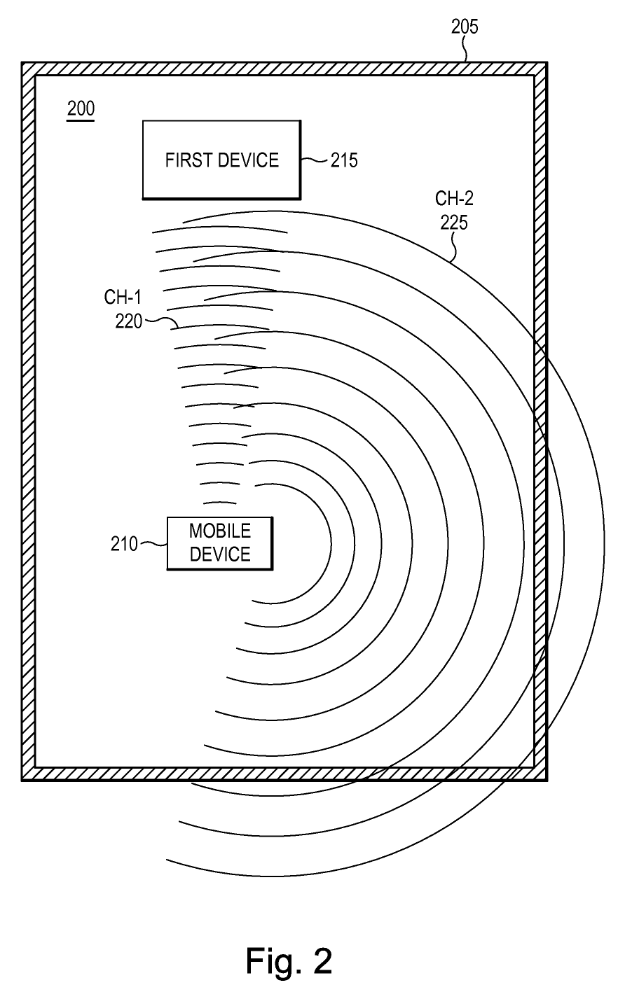

FIG. 2 is an illustration of channels utilized by an embodiment of a mobile device establishing a secure network. In this illustration, a mobile device 210 and a first device 215 are located in a room or other location 200, where the room or other location may include one or more walls 205. In some embodiments, the mobile device 210 uses a first wireless channel (CH-1) 220 for transmission of a request for external devices providing a function and for negotiating an ad hoc secure network with the first device 210 for the transmission of data on a second wireless channel (CH-2) 225.

As illustrated in FIG. 2, the first wireless channel 220 may be chosen to reduce the chance of the signal being received by a device or user that is not in close proximity to the mobile device 210. In some embodiments, the first wireless channel 220 may be short-range in comparison to the second wireless channel 225. Further, the first wireless channel 220 may be non-penetrating in comparison to the second wireless channel 225, and thus, for example, cannot easily pass through the walls 205 of the location 200. Further, the first wireless channel 220 may be directional, and thus may be directed towards the first device 215, rather than being multi- or omni-directional such as the second wireless channel 225.

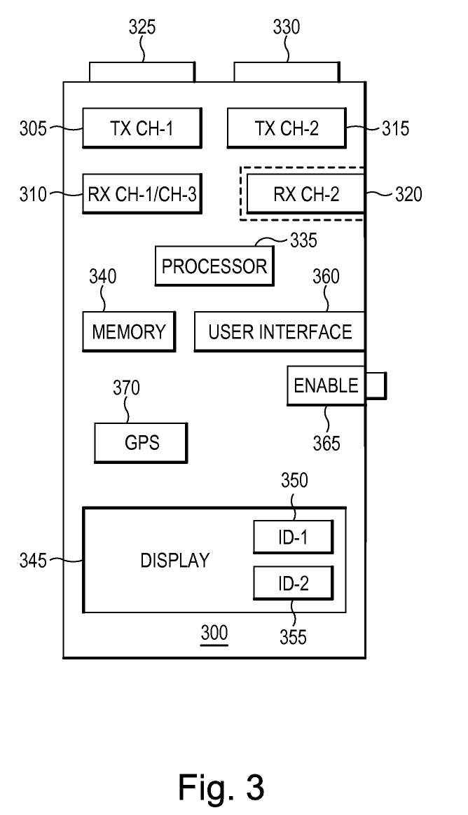

FIG. 3 illustrates an embodiment of a mobile device. In some embodiments, a mobile device 300 includes capability for communications in multiple wireless channels for the purpose of requesting a function from a device, negotiating and establishing an ad hoc secure network, and transmitting data via the secure network. In some embodiments, the mobile device 300 includes a first transmitter 305 for transmitting messages via a first wireless channel for the purpose of setting up an ad hoc secure network with a first device on a second wireless channel, and a first receiver 310 to receive messages from the first device, where the first receiver may utilize the first wireless channel or a third wireless channel. In some embodiments, the mobile device 300 further includes a second transmitter 315 to transmit data to the first device via the second wireless channel. In some embodiments the transmission from the mobile device 300 via the second wireless channel may be a one-way transmission. In some embodiments, the transmission between the mobile device 300 and the first device via the second wireless channel may be two-way, with the mobile device 300 further including a second receiver 320 for the receipt of data via the second wireless channel. In some embodiments, the mobile device 300 further includes a first antenna or other signal transmission/reception element 325 for the first wireless channel, third wireless channel, or both and, if such element 325 is not compatible with the second wireless channel, a second antenna or other signal transmission/reception element 330 for the second wireless channel.

In some embodiments, the mobile device 300 may further include a processor 335, the operation of the processor including the formation of requests for functions, the negotiation and set up of ad hoc secure networks, and the handling of data for transmission via the second wireless channel. In some embodiments, the mobile device 300 further includes a memory element for storage of data for transmission, and a user interface 360 that provides direction to a user in setting up an ad hoc secure network with another device including, but not limited to, a graphical user interface (GUI). In some embodiments, the mobile device 300 may include an enable button or feature 365, which a user may engage to put the mobile device 300 into an establish link state to discover external devices. In some embodiments, the mobile device 300 further includes a display 345, the display to include information regarding the set up of an ad hoc secure network. As illustrated, the display 345 may include display of identification information from devices that are responding to a request for a function, such as a first identifier for a first device (ID-1) 350 and a second identifier for a second device (ID-2) 355. In some embodiments, a responding device may also display an identifier, thereby assisting a user in comparing identifiers and choosing a correct device for an ad hoc secure network. In some embodiments, the mobile device 300 may include a location determination element such as a GPS (Global Positioning System) receiver 370.

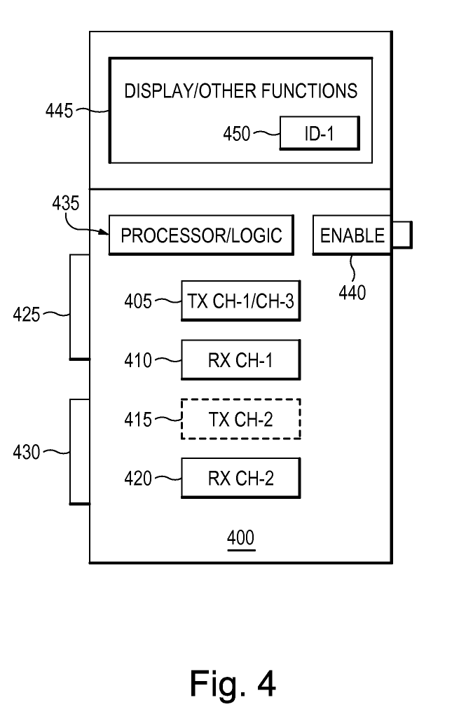

FIG. 4 illustrates an embodiment of an external device that may provide a function for a mobile device. In some embodiments, a device 400 includes a first receiver 410 for receiving, on a first wireless channel, requests from another device, such as mobile device 300 illustrated in FIG. 3, and for negotiating an ad hoc secure network on a second wireless channel with the other device. In some embodiments, a request may identify an external function to be provided by the device 400. The device further includes a first transmitter 405 for responding to requests and for negotiating the secure network, the first transmitter transmitting on the first wireless channel or on a third wireless channel. In some embodiments, the device 400 further includes a second receiver 420 for receiving data on the second wireless channel using the secure network, and in certain embodiments may include a second transmitter 415 for transmission of data on the second wireless channel if needed. In some embodiments, the mobile device 400 further includes a first antenna or other signal transmission/reception element 425 for the first wireless channel, third wireless channel, or both, and, if such element 425 is not compatible with the second wireless channel, a second antenna or other signal transmission/reception element 430 for the second wireless channel.

In some embodiments, the device 400 includes a processor or other logic 435 to provide for negotiation of the ad hoc secure network with another device. In some embodiments, the device 400 further includes an enable button or feature 440, which a user may engage prior to sending a request to put the device 400 into an establish link state such that the device responds to a request, which may occur if the device meets the requirements of the request. As illustrated in FIG. 4, the device 400 includes a display or other function 445. In some embodiments, if the device 400 is a display device, an announcement from the device 400 may include an identifier 450 (ID-1) on the display 445 in response to a request. A user may utilize the displayed identifier to compare against information received on a mobile device in order to ensure that the correct target device is being chosen for the network.

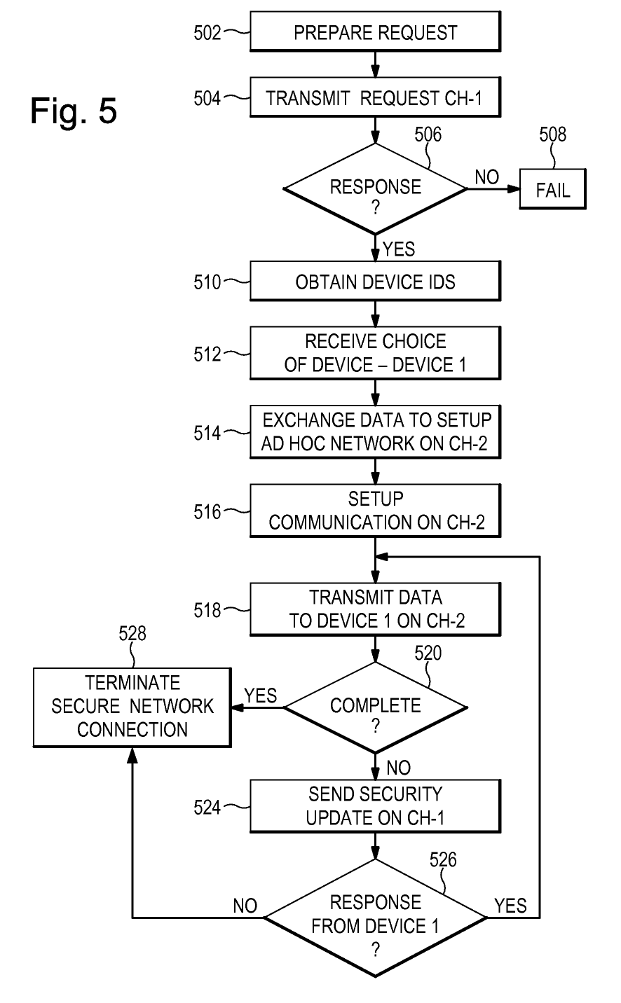

FIG. 5 is a flow chart to illustrate an embodiment of a process for set up of a secure network. All processes in such flowchart are not required and may be performed in varying order depending on the embodiment and on the particular set of occurrences. In some embodiments, a mobile device prepares a request for announcements from external devices 502, wherein the request may ask for devices providing a certain function to provide an announcement. The mobile device transmits the request to external devices 504. In some embodiments, the request is transmitted on a first wireless channel (CH-1), wherein the first wireless channel is a short-range wireless channel. In some embodiments, the first wireless channel is a non-penetrating, directional channel. In some embodiments, the mobile device intends to set up an ad hoc secure network on a second wireless channel (CH-2), where CH-2 may have greater bandwidth capability than CH-1.

In some embodiments, if the mobile device does not receive an announcement from a qualified device 506, the connection fails 508. If one or more announcements are received, the mobile device may receive device identifiers from the announcing external devices 510. In some embodiments, an announcement is received on CH-1, while in other embodiments the announcement may be received on a third wireless channel (CH-3). Upon receiving a choice of device from a user input 512, referred to herein as Device 1, the mobile device exchanges data with Device 1 required for setting up a network connection 514. The mobile device then sets up communication on CH-2 516, and proceeds to transmit data to Device 1 on CH-2 518.

In some embodiments, upon completing the required transmission 520, such as upon receiving an instruction to end the function from a user, the mobile device operates to terminate the secure network connection 528. In some embodiments, during the transmission the mobile device may send a periodic security update or request on CH-1 to maintain the connection 524. If the mobile device receives a response 526, the mobile device continues transmitting data to Device 1 518. If the mobile device does not receive a response 526, the mobile device operates to terminate the secure network connection 528.

In some embodiments, the mobile device may terminate the network connection based on other factors, including a determination that the mobile device has moved to another geographic location that is too far from the original location to maintain the secure network connection. The change in geographic location may be determined using any known method for location determination, including GPS functionality in the mobile device or location determined by a network link.

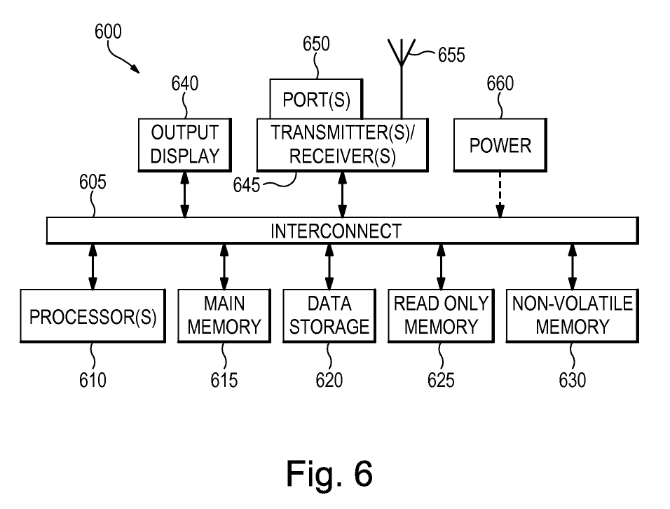

FIG. 6 illustrates an embodiment of a mobile device. In this illustration, certain standard and well-known components that are not germane to the present description are not shown. Under some embodiments, the mobile device 600 comprises an interconnect or crossbar 605 or other communication means for transmission of data. The device 600 may include a processing means such as one or more processors 610 coupled with the interconnect 605 for processing information. The processors 610 may comprise one or more physical processors and one or more logical processors. The interconnect 605 is illustrated as a single interconnect for simplicity, but may represent multiple different interconnects or buses and the component connections to such interconnects may vary. The interconnect 605 shown in FIG. 6 is an abstraction that represents any one or more separate physical buses, point-to-point connections, or both connected by appropriate bridges, adapters, or controllers.

In some embodiments, the device 600 further comprises a random access memory (RAM) or other dynamic storage device or element as a main memory 615 for storing information and instructions to be executed by the processors 610. Main memory 615 also may be used for storing data for data streams or sub-streams. RAM memory includes dynamic random access memory (DRAM), which requires refreshing of memory contents, and static random access memory (SRAM), which does not require refreshing contents, but at increased cost. DRAM memory may include synchronous dynamic random access memory (SDRAM), which includes a clock signal to control signals, and extended data-out dynamic random access memory (EDO DRAM). In some embodiments, memory of the system may include certain registers or other special purpose memory. The device 600 also may comprise a read only memory (ROM) 625 or other static storage device for storing static information and instructions for the processors 610. The device 600 may include one or more non-volatile memory elements 630 for the storage of certain elements.

Data storage 620 may also be coupled to the interconnect 605 of the device 600 for storing information and instructions. The data storage 620 may include a magnetic disk, an optical disc and its corresponding drive, or other memory device. Such elements may be combined together or may be separate components, and utilize parts of other elements of the device 600.

The device 600 may also be coupled via the interconnect 605 to an output display or presentation device 640. In some embodiments, the display 640 may include a liquid crystal display (LCD) or any other display technology, for displaying information or content to a user. In some environments, the display 640 may include a touch-screen that is also utilized as at least a part of an input device. In some environments, the display 640 may be or may include an audio device, such as a speaker for providing audio information, including the audio portion of a television program.

One or more transmitters or receivers 645 may also be coupled to the interconnect 605. In some embodiments, the device 600 may include one or more ports 650 for the reception or transmission of data. The device 600 may further include one or more antennas 655 for the reception of data via radio signals. In some embodiments, the device 600 is capable of utilizing multiple wireless channels, including the transmission of signals on a first wireless channel to negotiate the set up of an ad hoc secure network connection on a second wireless channel with another device.

The device 600 may also comprise a power device or system 660, which may comprise a power supply, a battery, a solar cell, a fuel cell, or other system or device for providing or generating power. The power provided by the power device or system 660 may be distributed as required to elements of the device 600.

In the description above, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form. There may be intermediate structure between illustrated components. The components described or illustrated herein may have additional inputs or outputs which are not illustrated or described.

Various embodiments of the present invention may include various processes. These processes may be performed by hardware components or may be embodied in computer program or machine-executable instructions, which may be used to cause a general-purpose or special-purpose processor or logic circuits programmed with the instructions to perform the processes. Alternatively, the processes may be performed by a combination of hardware and software.

Portions of various embodiments of the present invention may be provided as a computer program product, which may include a computer-readable medium having stored thereon computer program instructions, which may be used to program a computer (or other electronic devices) for execution by one or more processors to perform a process according to the embodiments of the present invention. The computer-readable medium may include, but is not limited to, floppy diskettes, optical disks, compact disk read-only memory (CD-ROM), and magneto-optical disks, read-only memory (ROM), random access memory (RAM), erasable programmable read-only memory (EPROM), electrically-erasable programmable read-only memory (EEPROM), magnet or optical cards, flash memory, or other type of computer-readable medium suitable for storing electronic instructions. Moreover, the present invention may also be downloaded as a computer program product, wherein the program may be transferred from a remote computer to a requesting computer.

Many of the methods are described in their most basic form, but processes can be added to or deleted from any of the methods and information can be added or subtracted from any of the described messages without departing from the basic scope of the present invention. It will be apparent to those skilled in the art that many further modifications and adaptations can be made. The particular embodiments are not provided to limit the invention but to illustrate it. The scope of the embodiments of the present invention is not to be determined by the specific examples provided above but only by the claims below.

If it is said that an element “A” is coupled to or with element “B,” element A may be directly coupled to element B or be indirectly coupled through, for example, element C. When the specification or claims state that a component, feature, structure, process, or characteristic A “causes” a component, feature, structure, process, or characteristic B, it means that “A” is at least a partial cause of “B” but that there may also be at least one other component, feature, structure, process, or characteristic that assists in causing “B.” If the specification indicates that a component, feature, structure, process, or characteristic “may”, “might”, or “could” be included, that particular component, feature, structure, process, or characteristic is not required to be included. If the specification or claim refers to “a” or “an” element, this does not mean there is only one of the described elements.

An embodiment is an implementation or example of the present invention. Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances of “an embodiment,” “one embodiment,” or “some embodiments” are not necessarily all referring to the same embodiments. It should be appreciated that in the foregoing description of exemplary embodiments of the present invention, various features are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims are hereby expressly incorporated into this description, with each claim standing on its own as a separate embodiment of this invention.

1. A method comprising:
sending a request from a mobile device, the request asking external devices to provide an announcement, the request being sent via a first wireless channel;
receiving announcements from one or more external devices including a first device;
transmitting data from the mobile device to the first device via the first wireless channel to negotiate a secure network;
establishing the secure network connection on a second wireless channel; and
transferring data securely from the mobile device to the first device via the second wireless channel using the secure network connection.

2. The method of claim 1, wherein the request includes a requested function to be provided by an external device.

3. The method of claim 1, wherein the response from the first device is received via the first wireless channel or a third wireless channel.

4. The method of claim 3, further comprising periodically transmitting messages to update the secure network connection via the first wireless channel.

5. The method of claim 4, further comprising terminating the secure network connection with the first device if the mobile device does not receive a response from the first device to a message to update the secure network connection within a certain time threshold.

6. The method of claim 1, wherein the announcement from the first device includes an identifier for the first device.

7. A mobile device comprising:
a processor to generate a request for an announcement from external devices;
a first transmitter to transmit the request via a first wireless channel;
a first receiver to receive announcements in response to the request from one or more external devices including a first device, the announcement from the first device including an identifier for the first device, wherein the processor is to send data using the first transmitter via the first wireless channel to establish a secure network connection for a second wireless channel; and
a second transmitter to transmit data from the mobile device to the first device via the secure network connection on the second wireless channel.

8. The mobile device of claim 7, wherein the request from the mobile device identifies a requested function to be performed by an external device.

9. The mobile device of claim 7, wherein the announcement from the first device is received via the first wireless channel or a third wireless channel.

10. The mobile device of claim 7, further comprising a second receiver to receive data via the first wireless channel.

11. The mobile device of claim 7, wherein the first wireless channel is a shorter range channel than the second wireless channel.

12. The mobile device of claim 7, wherein the first wireless channel has a narrower bandwidth than the second wireless channel.

13. The mobile device of claim 7, wherein the first wireless channel is less penetrating through solid objects than the second wireless channel.

14. The mobile device of claim 7, wherein the first wireless channel is a directional wireless channel.

15. The mobile device of claim 7, wherein the processor is to generate periodic messages during the operation of the secure network and to transmit the periodic message to the first device using the first wireless channel.

16. The mobile device of claim 15, wherein the processor is to terminate the secure network if the first device does not respond to a periodic message within a certain time threshold.

17. A system comprising:
a processor to generate a request for announcements from external devices;
a first transmitter to transmit the request via a first wireless channel;
a first receiver to receive a response to the request from one or more external devices including a first device, the request from the first device including an identifier for the first device, wherein the processor is to send data using the first transmitter via the first wireless channel to establish a secure network connection for a second wireless channel;
a second transmitter to transmit data from the mobile device to the first device via the secure network connection on the second wireless channel;
an memory element to hold data for transmission via the secure network; and
a GPS (Global Positioning System) receiver element to determine a location of the system.

18. The system of claim 17, wherein the request includes identification of a requested function to be performed by an external device.

19. The system of claim 18, wherein the requested function is a display function,

20. The system of claim 19, wherein the first wireless channel is an optical channel.

21. The system of claim 20, wherein the announcement from the first device includes a visual identifier for the first device.

22. The system of claim 18, wherein the requested function is a sound production function.

23. The system of claim 22, wherein the first wireless channel is an audio channel.

24. The system of claim 23, wherein the announcement from the first device includes an audible identifier for the first device.

25. The system of claim 17, wherein the processor is to terminate the secure network if the GPS receiver element detects that the system has moved out of range from the first device.

26. A computer-readable storage medium having stored thereon data representing sequences of instructions that, when executed by a processor, cause the processor to perform operations comprising:
sending a request from a mobile device, the request asking external devices to provide an announcement, the request being sent via a first wireless channel;
receiving announcements from one or more external devices including a first device;
transmitting data from the mobile device to the first device via the first wireless channel to negotiate a secure network;
establishing the secure network connection on a second wireless channel; and
transferring data securely from the mobile device to the first device via the second wireless channel using the secure network connection.

27. The medium of claim 26, wherein the request includes a requested function to be provided by an external device.

28. The medium of claim 26, further comprising instructions that, when executed by the processor, cause the processor to perform operations comprising:
periodically transmitting messages to update the secure network connection via the first wireless channel.

29. The method of claim 28, further comprising instructions that, when executed by the processor, cause the processor to perform operations comprising:
terminating the secure network connection with the first device if the mobile device does not receive a response from the first device to a message to update the secure network connection within a certain time threshold.
